(19) United States
(12) Patent Application Publication
(10) Pub. No.: US 2010/0075747 A1
(43) Pub. Date: Mar. 25, 2010

(54) Player Club Ladder Method For Casino Gaming

(75) Inventor: Marvin Hein, Las Vegas, NV (US)

Correspondence Address: STEPTOE & JOHNSON, LLP, 2121 AVENUE OF THE STARS, SUITE 2800, LOS ANGELES, CA, 90067, US

(73) Assignee: BALLY GAMING, INC., Las Vegas, NV (US)

(21) Appl. No.: 12/235,478

(22) Filed: Sep. 22, 2008

(51) Int. Cl. G06F 17/00

(52) U.S. Cl. 463/29

(57) ABSTRACT

The present invention is generally directed to a method for enabling a player club ladder. The method includes arranging a main group of players registered in the player club into sub-groups, and during a challenge period, only players in the same sub-group compete against one another. Information about the player club challenge period is sent to the players, including identification of other players in their sub-group. During the challenge period, players log into a gaming machine and the game play data created by the participating players is tracked by the system. Points acquired by players at the gaming devices are monitored during the challenge period, and the players within each sub-group are ranked based on points accumulated during the challenge period. At the end of the challenge period a bonus or prize is provided to at least one player within each sub-group based on the total amount of points.

### CROSS-REFERENCE TO RELATED APPLICATIONS

This application is related to co-pending U.S. patent application Ser. No. 12/235,462, filed Sep. 22, 2008.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

Casinos typically enroll players in loyalty programs, such as player clubs. Player tracking systems are used to monitor the gaming activities of players enrolled in player clubs on a casino floor. A common method for monitoring casino players is via a player tracking system. Typically, these systems use cards to identify a player. The player inserts the card before playing a game on the casino gaming machine. The player tracking system uses the information stored on the card to identify the player. Once the player tracking system identifies the player, the system then monitors the player's gaming habits. This includes recording player wagered amounts and the rate at which the player plays the games, and the like. Data relating to the player's gaming habits is then stored in a player tracking system database and/or on the player tracking card.

Currently, there is no real incentive for players in a player club to accumulating points in their player's account other than receiving a “comp” from the casino. There is no competition among players within a player club and play within the player club is generally private and lonely. What is needed is a system and method that encourages players to play more than normal at the gaming devices to earn more points on a player's account during a finite period of time. Providing incentives to move up the rungs of the ladder will translate into players spending more time and money gaming at the benefit of the casino.

### SUMMARY

Briefly, and in general terms, various embodiments are directed to a method for performing a casino gaming system including a player club ladder. One embodiment of a method for enabling a player club ladder includes arranging a group of players registered in the player club into sub-groups, and only players in the same sub-group compete against each other. The sub-groups can be viewed as rungs of a ladder, with players in higher rungs competing for bigger prizes. The method further includes announcing a challenge period to the players in the player club, and initiating the challenge period. It may be required for players to register in the player club in advance. The player club server or module may send out information about the player club challenge to the participating players, including identification of other players in their sub-group, whom they are competing against. During the player club challenge period (for example, a week or month), players log into a gaming machine by providing player tracking information so that the player tracking system or the player club server can track game play data created by the participating players.

In one embodiment, the game play data from each player may be normalized into a tournament score or points by the player tracking system or the tournament server. Player club points acquired by players at the gaming devices are monitored during the challenge period, and the players within each sub-group are ranked based on points accumulated during the challenge period. The system may update player rankings within the sub-groups periodically or in real-time. At the end of the tournament period an award, bonus or prize is provided to the players within the sub-groups based on the total amount of points accumulated on the gaming devices during the player club challenge period. The award, bonus or prize may be in addition to any winnings accumulated on the gaming devices by the players.

In one embodiment, the updated player rankings within the sub-groups are presented to the players via the gaming devices themselves, or a player tracking display associated with the gaming device. During and after the player club challenge period, players also may retrieve ranking information via the Internet. The system may post player ranking and other information on a web-site that can be accessed by the participating players.

It has been contemplated that a player may be repositioned from one sub-group (rung of the ladder) into another sub-group (rung of the ladder) based on the player's performance during the challenge period. Higher rungs may have bigger prizes or bonuses available to winning players. This provides players with an incentive to increase their play during tournament periods.

In one embodiment, players in the player club may compete on any gaming machine of their choosing, and the player club server will normalize all scores for comparison to other players in the sub-group. In another embodiment, certain machines or types of games must be played during the player club challenge period.

Other features will become apparent from the following detailed description, taken in conjunction with the accompanying drawings, which illustrate by way of example, the features of the various embodiments.

### BRIEF DESCRIPTION OF THE DRAWING

FIG. 1 depicts one embodiment of a tournament ladder with a main group of players placed within sub-groups;

FIG. 2 depicts a diagram of one embodiment of a gaming system including a tournament server in communication with a plurality of gaming machines;

FIG. 3 depicts one embodiment of a gaming machine that is a part of the system shown in FIG. 2;

FIG. 4 depicts a flow diagram of one embodiment of a method for instituting a tournament ladder; and

FIG. 5 depicts one embodiment of a reporting screen providing tournament information to players.

### DETAILED DESCRIPTION

Generally, various embodiments disclosed herein are directed to a casino gaming system and method including a player club ladder. The player club ladder consists of several rungs or sub-groups, with each rung containing a number of players. Players in each sub-group compete against one another for a chance to win prizes and advance into a higher rung of the player club ladder. Higher rungs on the player club ladder offer bigger prizes or bonuses.

During existing player clubs, players merely accumulate points in player accounts, and there is no real incentive to accumulate points, other than receiving a “comp,” such as a free meal or room upgrade at the hotel. In the player club ladder system, players accumulate points to stay ahead in the standings and win prizes in each sub-group. Players receive and can view standings of all players in the same sub-group during a set period of time or challenge period, thereby making the player clubs more competitive and public versus existing player clubs that are somewhat lonely and private. The player club ladder system encourages players to earn more points (by playing slot machines in a regular mode) during a finite period because they are competitive with their peers in the same sub-group.

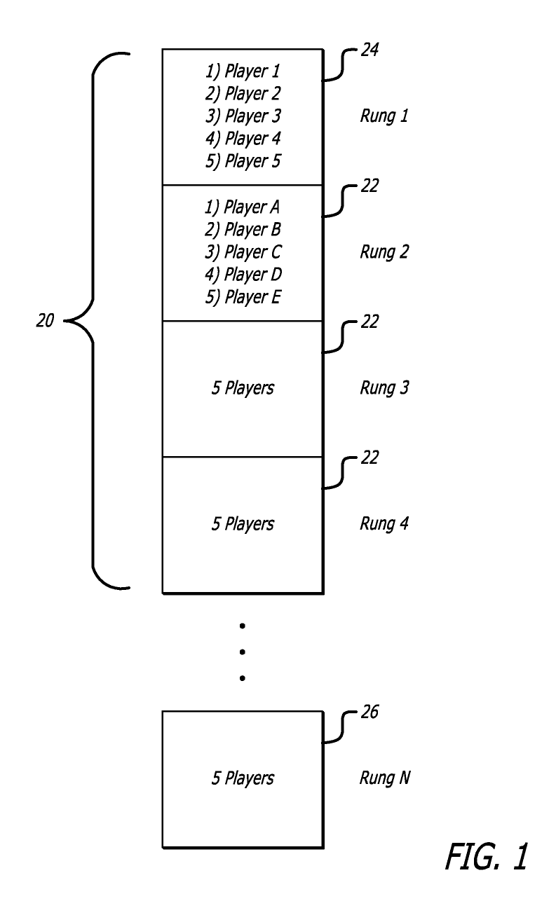

Referring now to the drawings, wherein like reference numerals denote like or corresponding parts throughout the drawings, there are shown various embodiments of a casino player club gaming system including a player club ladder. In one embodiment shown in FIG. 1, a registered player population 20 or main group for the player club is divided into sub-groups 22, which may be thought of as rungs of a ladder. Each sub-group 22 can have any number of players (5, 10, 20, etc.), and the players within each sub-group are ranked based on performances during a challenge period. The sub-groups themselves are ranked in order from the highest or top rung 24 to the lowest or bottom rung 26, with higher rungs including higher valued prizes compared to lower rungs. In one embodiment, players have the opportunity to advance and play in a higher sub-group to compete for prizes with a higher value. For example, the winner of each rung might automatically advance to the next higher rung during the next challenge period. Similarly, the lowest player in each rung might automatically be placed at the top of the next lower rung during the next challenge period.

The sub-groups 22 should be sized so that a player feels that even a small amount of play will help advancement in the standing within the sub-group, or so that the player feels there is a chance to win the top prize in the sub-group. Generally, it has been contemplated that the players with similar point accumulations during challenge periods will compete against one another in the sub-groups. For example, top point accumulators will compete against one another in a higher ranked sub-group 24, while lower point accumulators will compete against one another in a lower ranked sub-group 26. This style of grouping players allows a player to be competitive against other opponents in the same sub-group 22 without making drastic changes to the player's style of play. Ideally, a number of players in the sub-group 22 will become competitive during the challenge period and will play more than normal, thereby, increasing revenues for the casino or player club administrator. In one embodiment, the size of the sub-groups 22 can be decided on a trial basis and the number of players in each sub-group 22 can be scaled up or down based on actual participation by members of the player club.

In some embodiments, the size of each rung or sub-group 22 may vary depending on the value of the prizes associated with each sub-group. For example, a sub-group 22 with a large number of players (perhaps players in a lower rung) may compete for points while a mid-range set of rungs might compete for small rung progressive jackpots, and a small select group of top rung players might compete for a very special large prize, such as a car, or any other large value prize. However, any prize, bonus, credits, points, or combination thereof may be available for any of the sub-groups. In one embodiment, the sub-groups 22 could compete for a progressive jackpot, where the units for the progressive jackpot are player points.

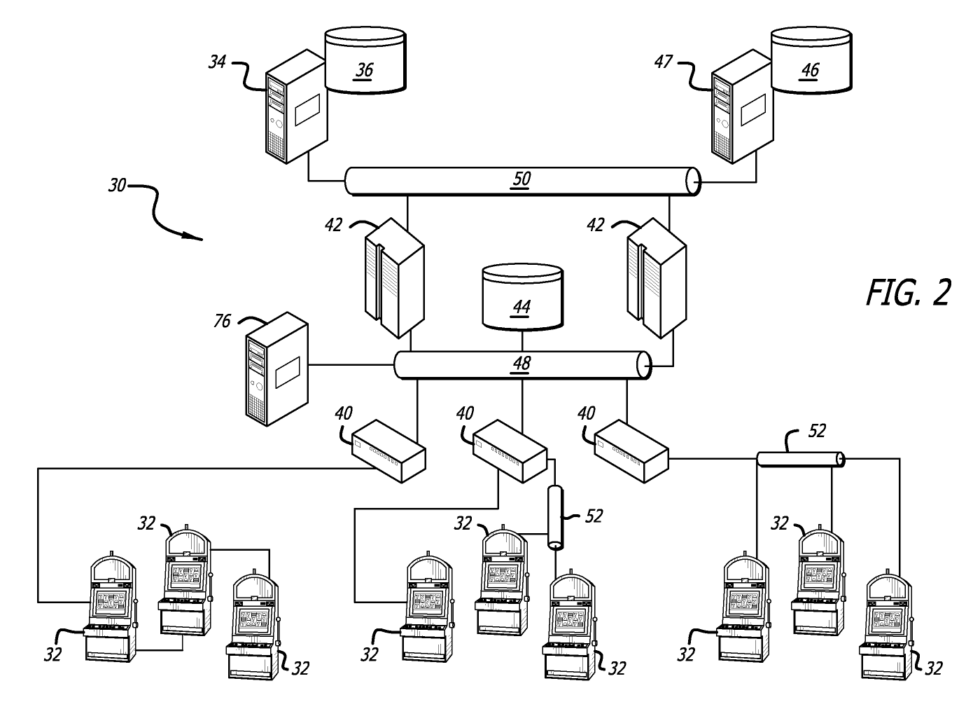

Referring now to FIG. 2, a network system 30 is shown to include a plurality of gaming devices or machines 32 in communication with a player club server 34 or a player club module. The player club server stores groupings of players participating in a player club along with individual player information in a database 36 associated with the server. The player club server 34 includes a processor for ranking the players within each grouping or sub-group based on points accumulated while playing the gaming devices. Also, the player club server 34 is capable of sending real-time ranking information to the individual players during and after a player club event. In one embodiment, players will receive a list of rankings in their own sub-group. The information sent by the player club server to the players may be accessed via the Internet or at the individual gaming devices 32 themselves. In other embodiments, emails or text messages may be sent to individual players with updated player club information including rankings, amount of time left in the player club, prize schedule, etc.

Preferably, but not necessarily, the gaming machines 32 are broadband-capable in that the gaming machines (or components inside them) accept higher speed, full-duplex, packetized messages. In one embodiment, gaming networking bridges 40 communicate with the gaming machines 32. The gaming network bridge 40 provides communication with and couples the gaming machines 32 to the network. Backend devices, such as slot data, player club and system game servers 34, 42, 44, 46, and 47 are connected to the gaming network through the bridge 40. In one embodiment, backend network structures 48 and 50 connect the data, player club, and system game servers from various locations outside and inside a casino or location of the player club. For example, and not by way of limitation, in one embodiment, the backend network structures 48 and 50 include a local area network 48 system, and a wide area network system 50. Further, software applications executing in the player club server 34, with respective database 36, the devices 42, the common database 44, and slot or player management and marketing server 47, with their respective database 46, function collectively or individually as game controllers.

In some embodiments, one or more protocols are used to communicate in the network. For example, and not by way of limitation, the network uses high-speed broadband communication and packetized protocol to communicate player club data in the network. The protocol may comprise, for example, and not by way of limitation, Ethernet, TCP/IP and XML based GSA BOB available from the Gaming System Association of Las Vegas, Nev. Further, in one embodiment, for consistency in protocol, messages from gaming devices 32 are routed through broadband communication pipes 52 to the bridges 40.

The system may also include a management console (not shown) that is in communication with the player club server 34, and the management console has a user interface for inputting player information during enrollment of the players into the main group 20 of the player club. Players' information may also be changed or updated using the management console. Further, an administrator can set the challenge period, set prizes for each sub-group 22, register players for player clubs, set the size of each sub-group, re-rank or order players into separate sub-groups, and cause player club information and rankings to be sent out to the individual players, among other functions.

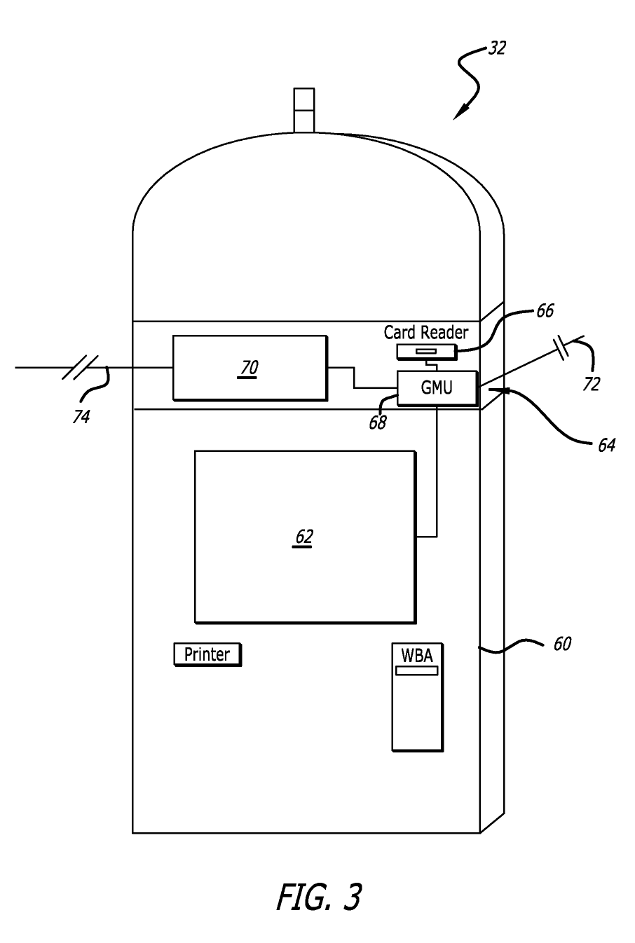

With reference to FIG. 3, a block diagram illustrates a gaming device 32 according to one embodiment. A base game cabinet 60 is included that provides for regular game play on the gaming machine 32. A base game display 62 displays regular base game play, player club or tournament game play. The base game may include, for example, and not by way of limitation, poker games, slot games, keno, and the like. Depending on the type of player club, when a player logs into a gaming machine, the player club game play will automatically be activated. During player club or tournament game play, players may only compete for points and may not be required to insert or transfer funds to the gaming machine 32. In other embodiments, only the regular base game play is needed for competition in the player club ladder. In this mode, the gaming machine 32 operates as normal with players transferring funds into the machine and playing for credits, which may be cashed out or transferred to a player's account.

A player tracking cabinet module 64 provides a card reader 66, game management unit (GMU) 68, and an additional user interface 70. In one embodiment, the additional user interface is an IVIEW interface 70 (available from Bally Technologies, Inc. of Las Vegas Nev.), which serves as an additional user interface for playing system games off of system game server 42. In some embodiments, an additional user interface is referred to herein as a player tracking user interface. However, in other preferred embodiments, system games or player club games are not played off of system game server 34 and 42, but rather utilize a distributed processing environment, software-based processing components, a “stand-alone” processing system, or combinations thereof.

In one embodiment, the GMU 64 monitors game play and provides as one line of communication 72, a network connection to slot management and player marketing servers 47. In another aspect of a preferred embodiment, the IVIEW interface 70 includes a web content capable display screen and an embedded processor. Preferably, in addition to displaying system gaming related information, the display screen is also capable of presenting mark-up or web compatible information to a user via the display screen. The embedded processor preferably utilizes an internal operating system and communicates with a gaming processor of the base game. The additional user interface further provides broadband network connection 74 to the gaming network as described with respect to FIG. 1.

In some embodiments, any one or more of the components of the gaming machine 32 can be embodied in software services and merged into another component without a network connection between them. For example, and not by way of limitation, the card reader 66 can be internet protocol (IP) based, or hardwired to a specific component, such as the GMU 68, through a serial, USB or connection.

In one embodiment, the system also includes a player tracking system that is in communication with the plurality of gaming devices to monitor players' gaming during the challenge period. The player tracking system can also be in communication with the player club server 34 to transfer players' gaming activity to the player club server. Typically the player tracking system includes a player tracking device and/or display that is embedded within the gaming machines. In other embodiments, the player club server 34 may track player's game play during challenge periods.

One embodiment of a method for enabling a player club ladder allows players in a player club to compete against opponents in a sub-group with similar gaming habits. This method also allows the player to compete against other players in a player club any time during a challenge period. In some embodiments, players may compete in the player club by playing any number of regular base games. To join the main player population 20, players must enroll in the player club. Players may register by any conventional manner, including submitting a sign-up form at a casino or other establishment, over the internet, or over the telephone. As part of joining the player club, players may be required to provide a “handle,” screen-name, or alias, and an email address. Optionally, players may wish to be identified by a number. All information regarding the players in the player club is stored on the player club server 34 or database 36, or on any server or database associated with the network.

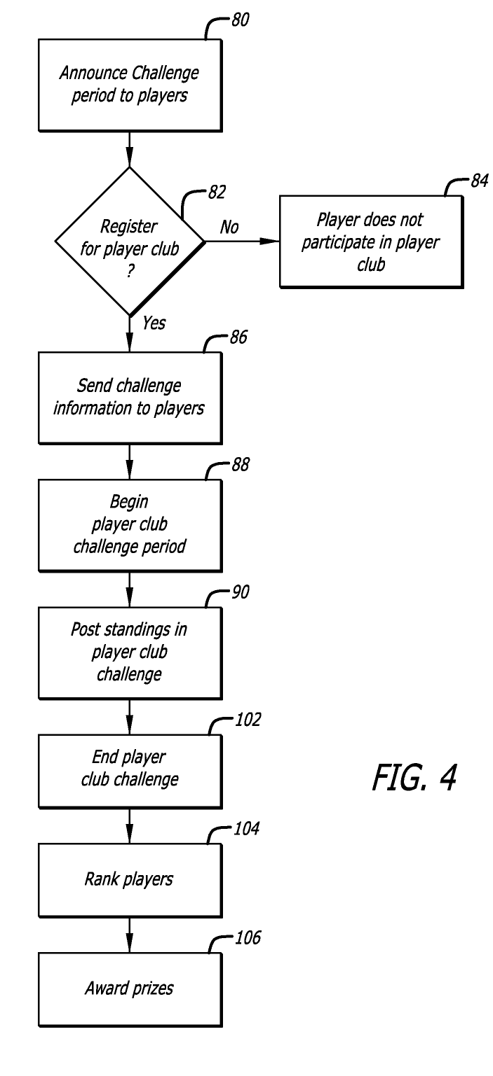

As shown in the flow diagram of FIG. 4, one embodiment of the player club system includes announcing a challenge period to players in the player club as shown at step 80. In this embodiment, the player club server 34 sends the announcement to the main population 20 of players in the player club. The network system 30 may include a chat server 76, as shown in FIG. 2, to send information to players via the Internet, text message, phone message, or other method. The announcement can be sent via the player club server 34 or other backend server 42, 44, 46, or 47 to the players via the wide area network 50 to the player's email accounts or cell phones (text message). Announcements may also be sent out via regular mail to the players, or by any other notification method.

In one embodiment, players may register for the player club if they are not already members of the player club as depicted at request 82. If the player does not register for the player club(s) as shown in step 84, the player will not be able to participate in player club challenge. For those players that are registered in the player club(s), the player club server 34 or module (located anywhere in the network system 30) may then send out information (via email or other method) about the player club challenge to the registered players as shown at step 86. In one embodiment, players may also be required to pay a fee (in cash or points) in order to participate in the player club(s). It has been contemplated that players may pay no fee, may pay a yearly fee, or pay the player club fee with previously acquired points.

Player club information may include identification of other players in their sub-group whom they are competing against, available prizes that players are competing for, and the start and end times of the challenge period. Different prize structures for each sub-group or range of sub-groups may be established by the casino or administration. Available prizes may be points, cash, any item, “comps,” etc. A possible prize might include enhanced point accumulation during a subsequent period. Players should be informed about their current rung and it should be made clear to the players that higher rungs or sub-groups have more desirable prizes. This gives players an incentive to accumulate points in order to transfer into higher rungs or subgroups in future player clubs. Providing incentives to move up the rungs of the ladder will translate into players spending more time and money gaming at the benefit of the casino.

Challenge periods may be hours, days, weeks, or any other length of time. However, in one embodiment, challenge periods need to be long enough so that players have a chance to view the standings and compare themselves to the other competitors in the same sub-group 22, and have time to return to the casino and continue to play the gaming machines during the remainder of the challenge period. The player's efforts to accumulate more points than their competitors will increase the time normally spent on the gaming machines. It is the player's accumulated score at the end of the challenge period that ranks them in a possibly higher rung or sub-group 22 for the next challenge period. Using points to advance into a higher rung or sub-group 22 provides the players with an incentive to accumulate more points during challenge periods.

In one embodiment, administrators may set the challenge periods to different lengths depending on the type of player club, time of year, available incentives, or other factors. By establishing different player club start dates and durations, a casino or administrator may be able to offer multiple player club ladders to players at the same time.

After the registration process, the player club challenge begins as indicated at step 88 of FIG. 4. During the challenge period, players log into the gaming machine by providing player tracking information so that the player tracking system or the player club server 34 can track game play data created by the participating players. The game play data from each player may be normalized into a player club score or points by the player tracking system or the player club server. Player club points acquired by players at the gaming devices are monitored during the challenge period, and the players within each sub-group are ranked based on points accumulated during the challenge period. Normalizing player data allows the player club to be played on different base games.

At step 90, the system may post standings to update player rankings within the sub-groups periodically or in real-time. At the end of the challenge period a bonus or prize is provided to at least one player within each sub-group based on the total amount of points accumulated on the gaming devices during the challenge period. The bonus or prize may be in addition to any winnings accumulated on the gaming devices by the players. Once the challenge period begins, the player club standings may be sent by the player club server 34 to the display 62 of the gaming machines 32 or secondary display associated with the gaming machine. Also, standings may be sent via the Internet to players' email accounts, or to a web-site that players may check to see their standing in the sub-group. These standings may be automatically posted on a screen along with other player information when the player logs onto the player club web-site, or the standings may be a specially requested report accessible through the web-site. Similarly, players' standings may be announced or requested as part of the player tracking screen options at the gaming machine 32.

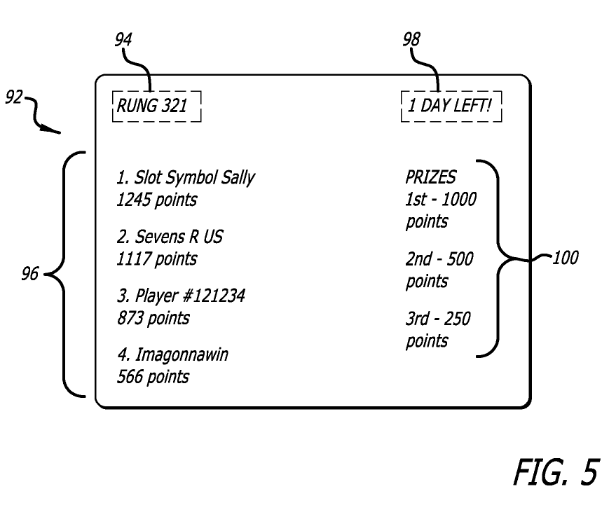

In general, an updated window or display 92 shown in FIG. 5, may be received by the players and include the sub-group designation 94, standings 96 showing aliases or “handles” and current point standings of the ranked sub-group members, time left 98, prize structure 100, etc. In one embodiment, point standings reflect the players' total player club points. In another embodiment, point standings may reflect only points acquired during the challenge period. This updated window or display 92 may be accessible to all players at all times during and after the challenge periods. In certain embodiments, players may be emailed, sent text messages or otherwise informed regarding the standing information at one or more intervals prior to the end of the challenge period.

At the end of the challenge period, the player club ends as indicated at step 102. The player club server 34 ranks the players in each sub-group 22 according to points accumulated during the challenge period at step 104 of FIG. 4. At step 106, prizes are then awarded based on player ranking within each sub-group 22. In one embodiment, each player in a sub-group, in addition to their regular point or credit accumulation from the gaming machine 32 will be eligible to receive additional prizes based on their total point accumulation during the challenge period relative to others in their sub-group. The players with the highest point accumulation at the end of the period will receive the most valued prizes, and the players at the bottom of the sub-group will receive lower valued prizes, and perhaps nothing. Prize structures are established by the casino or administrator of the player club.

It has been contemplated that players may be repositioned from one sub-group 22 (rung of the ladder) into another sub-group 22 (rung of the ladder) based on the players performance during the preceding challenge periods. Higher rungs may have bigger prizes or bonuses available to winning players. Periodically re-ordering the sub-groups 22 keeps players with similar gaming habits competing against one another even as players' habits change over time.

In one embodiment, the player clubs challenges can be played on any gaming device with any type of base game. However, certain player club challenges may require players to compete on the same base game. In other embodiments, players may compete against each other on dissimilar gaming machines for potentially varying periods of time while such players are concurrently playing their gaming machines in a normal fashion or normal mode. In one embodiment, the player club challenges use gaming machines with non-modified base games located anywhere in the casino, or two or more casinos, while the players of those gaming machines continue to participate in normal play on the plurality of gaming machines.

In one embodiment, a player can compete with players during the challenge periods, in any other facility around the world, if the system is configured to do so through, e.g., a wide-area network 48. The players do not have to all start at the same time. Each player plays his base game at any point during the challenge period, or for a specific amount of time, the amount of money played, or the money won, or combinations thereof in order to generate a player club score. The player club server 34 will group these factors dynamically against other players to create competition for prizes or merely entertainment. The player clubs can be provided for free using promotional funds or pay to play, which provides incremental income per unit time per square foot of the casino floor.

On each gaming machine, a player plays the base game, as the player normally would, by inserting enough money into the gaming machine to begin play of the base game. Each win per wager amount is accounted for by the player club server 34 and/or the IVIEW interface on the gaming machine. In other embodiments, gaming machines may be dedicated for player club challenge play, and no money would need to be inserted into the gaming machine if the player is registered for the player club challenge. In this embodiment the player club server or player tracking system would track points accumulated by the player.

In one embodiment, player club point and credit data is processed into a player club score by comparing what the player won verses what was expected to win for the machine on which the player was playing. In one example, and not by way of limitation, a base game player club score is normalized in the calculation that follows:
$1.00 wager on the base game with a 95% theoretical payout percentage for the base game.
Expected win amount: $0.95.
Actual win amount: $1.65 1.65/$0.95*Scaling factor=Player club score for this last game.

In one embodiment, no base game reconfiguration is needed for the gaming machine 32 to participate in a player club. There is no requirement that gaming machines are dedicated to player club use or have special high-return player club-only pay schedules. In one embodiment, any gaming machine in the casino can be used. All the gaming machines on the floor are capable of being played in player club mode, even against other base games with different parameters. These differences in parameters include, by way of example, and not by way of limitation, different theme games with different payout percentages, available denominations, different wager amounts, different pay tables, different volatilities, different bonus rounds, and the like. In one embodiment, the different parameters are normalized for the player club by the scaling or weighting factor applied to each score described above.

In one embodiment, game play winnings are added to a winning player's account to allow replay of the winnings, cashing out, or redeeming for a prize at a later time. In one embodiment, a prize award may be automatically or manually paid by casino personnel who are notified of the win.

In one embodiment, the player club ladder system may hold a challenge with an extending duration, such as a year. During the duration of the large player club challenge, several small player club challenges can be held that require player participation. Players may compete in the small challenges during the year in attempts to move up rungs or sub-groups 22 on the ladder of the large player club population. At the end of the large player club duration, players will receive prizes based on their ranking within the sub-group they are positioned in at the end of the year, or based on their ranking within the entire player club population. Players may continue to win prizes or points during the small player clubs, and also win larger prizes at the end of the large player club challenge.

It has also been contemplated that the player club ladder system described herein can be used during tournament play as well. The tournament could be announced to players in the player club and then players may register for the tournament, which could last any period of time. During the tournament, player information would be sent to players competing against other players in the same sub-group. At the end of the tournament, the players are ranked within each sub-group and prizes or points are awarded to certain players.

One of ordinary skill in the art will appreciate that not all player club ladder systems have all these components and may have other components in addition to, or in lieu of, those components mentioned here. Furthermore, while these components are viewed and described separately, various components may be integrated into a single unit in some embodiments.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A method for operating a player club ladder, comprising:
arranging a main group of players into sub-groups and storing in memory the sub-groups;
announcing a challenge period to the players in each sub-group;
initiating the challenge period;
receiving player tracking information from gaming devices played by the players in each sub-group;
awarding points to each player in the sub-groups based on the player tracking information received during the challenge period;
concluding the challenge period;
ranking the players within each sub-group; and
providing an award to at least one player within each sub-group at the conclusion of the challenge period.

2. The method of claim 1, wherein the award is based on the total amount of points accumulated by the at least one player.

3. The method of claim 1, wherein the award is in addition to any winnings accumulated on the gaming devices by the at least one player.

4. The method of claim 1, wherein the players are ranked according to their respective points accumulated during the challenge period.

5. The method of claim 1, wherein the awarded points are player club points.

6. The method of claim 1, wherein the awarded points are not player club points.

7. The method of claim 1, further comprising presenting updated player rankings within the sub-groups to the gaming devices.

8. The method of claim 7, further comprising presenting the updated player rankings within each sub-group to a web-site, wherein the players may log into the web-site to view the rankings.

9. The method of claim 7, further comprising updating the player rankings within each sub-group periodically.

10. The method of claim 1, further comprising enrolling a player into the main group and placing the player into one of the sub-groups.

11. The method of claim 10, further comprising announcing players participating in the challenge period to other players within the same sub-group.

12. The method of claim 1, wherein the award provided to the players is relative to the other players in the same sub-group.

13. The method of claim 1, wherein receiving player tracking information at gaming devices includes receiving a player tracking card.

14. The method of claim 1, further comprising receiving player input to establish a player alias, wherein the aliases of players are shared among players in the same sub-group.

15. The method of claim 1, further comprising repositioning players from one sub-group into another sub-group based on the players' performances during the challenge period.

16. A method for operating a player club ladder, comprising:
grouping players from a main group into sub-groups;
announcing a challenge period and a roster of participating players to the players in the same sub-group;
initiating the challenge period;
tracking game play data created by participating players at a casino gaming device during the challenge period;
converting game play data into a normalized score to substantially equalize differences resulting from base games that have differing sets of parameters;
ranking participating players within each sub-group based on the normalized score;
updating participating player rankings in real-time;
sending participating player rankings to players in the same sub-group during the challenge period; and
concluding the challenge period.

17. The method of claim 16, further comprising storing in memory information involving each sub-group.

18. The method of claim 16, wherein participating player rankings are sent to players of the same sub-group through the casino gaming machine.

19. The method of claim 16, wherein participating player rankings are sent to players of the same sub-group through a web-site.

20. The method of claim 16, further comprising receiving player tracking information from participating players at the casino gaming devices.

21. The method of claim 16, wherein converting game play data into a normalized score includes normalizing for player wager amounts.

22. A method for operating a player club ladder, comprising:
storing in memory a main group of players;
grouping the main group of players into sub-groups and storing in memory each sub-group;
setting a challenge period;
initiating the challenge period;
tracking game play data created by players in each sub-group at a casino gaming device during the challenge period;
converting game play data into a score;
ranking players within the same sub-group based on the scores;
updating the rankings of players within the same sub-group in real-time;
sending players within the same sub-group updated rankings during the challenge period; and
concluding the challenge period.

23. The method of claim 22, further comprising awarding at least one player in each sub-group a prize based on the rankings at the end of the tournament period.

24. The method of claim 23, wherein the award is in addition to any winnings accumulated on the gaming devices by the at least one player.

25. The method of claim 22, further comprising awarding at least one player in each sub-group a prize based on the score.

26. The method of claim 22, wherein converting game play data into a score includes normalizing for player wager amounts.

27. The method of claim 22, further comprising receiving player tracking information from players at a player tracking device embedded into the casino gaming machine.
